(19) United States
(12) Patent Application Publication
(10) Pub. No.: US 2022/0318726 A1
(43) Pub. Date: Oct. 6, 2022

(54) METHOD, DEVICE, SYSTEM AND MEDIUM FOR LOCATING STORAGE SPACE IN WAREHOUSE

(71) Applicant: Beijing Jingdong Qianshi Technology Co., Ltd., Beijing (CN)

(72) Inventors: Wei LI, Beijing (CN); Peiling KONG, Beijing (CN)

(21) Appl. No.: 17/596,727

(22) PCT Filed: Mar. 13, 2020
(86) PCT No.: PCT/CN2020/079254

§ 371 Date: Dec. 16, 2021

(30) Foreign Application Priority Data
Jun. 18, 2019 (CN) 201910527432.0

(51) Int. Cl. G06Q 10/08; G06K 19/06

(52) U.S. Cl. CPC G06Q 10/087; G06K 19/06037

(57) ABSTRACT

A method for locating a storage space in a warehouse is provided, including: acquiring a plurality of storage space nodes and a plurality of storage spaces in the warehouse; establishing respective mapping relationships from the plurality of storage spaces to the plurality of storage space nodes; determining coordinates of each of the plurality of storage space nodes; acquiring an item to be operated, and determining a storage space to be operated for the item to be operated; determining a target storage space node corresponding to the storage space to be operated according to the mapping relationships; and outputting coordinates of the target storage space node. A device, a system and a medium for locating a storage space in a warehouse are also provided.

### CROSS-REFERENCE TO RELATED APPLICATION

This application claims priority to Chinese Application No. 201910527432.0, filed Jun. 18, 2019, incorporated herein by reference in its entirety.

### TECHNICAL FIELD

The present disclosure relates to a field of warehouse management, and more specifically, to a method, device, system, and medium for locating a storage space in a warehouse.

### BACKGROUND

Order picking refers to traversing a warehouse and picking out an item from goods scattered on inventory shelves according to contents of an order or a list of order sets. In an existing logistics warehouse, a worker is usually needed to push a picking trolley to a storage space of an inventory shelf, picking out a corresponding item and carrying the item to a designated position.

In order to improve an efficiency of order picking, in the picking process, a robot may be used for carrying goods instead of manual transportation. Therefore, how to determine a picking position and guide the robot to reach the picking position has become an urgent problem to be solved.

### SUMMARY

In view of the above, a method, device, system and medium for locating a storage space in a warehouse are provided according to the present disclosure.

In one aspect, a method for locating a storage space in a warehouse is provided, including: acquiring a plurality of storage space nodes and a plurality of storage spaces in the warehouse; establishing respective mapping relationships from the plurality of storage spaces to the plurality of storage space nodes; determining coordinates of each of the plurality of storage space nodes; acquiring an item to be operated, and determining a storage space to be operated for the item to be operated; determining a target storage space node corresponding to the storage space to be operated according to the mapping relationships; and outputting coordinates of the target storage space node.

According to the embodiments of the present disclosure, the establishing respective mapping relationships from the plurality of storage spaces to the plurality of storage space nodes includes: acquiring a mapping table, wherein the mapping table is used for storing mapping relationships between storage space nodes and a set of storage spaces; acquiring a quick response code provided for a storage space; and determining, in response to the storage space represented by the quick response code being not in the mapping table, a storage space node corresponding to the storage space represented by the quick response code according to a preset rule, and adding a mapping relationship from the storage space represented by the quick response code to the storage space node to the mapping table.

According to the embodiments of the present disclosure, the preset rule includes: a plurality of storage spaces correspond to one storage space node, and all storage spaces in the same storage space column correspond to the same storage space node.

According to the embodiments of the present disclosure, the warehouse includes a plurality of lanes, and a plurality of shelves are arranged in the lanes, the determining coordinates of each of the plurality of storage space nodes includes: determining, for each lane of the plurality of lanes, coordinates of an i-th storage space node in the lane as (xᵢ, yᵢ, zᵢ), an extension direction of the lane being parallel to an x-axis, wherein xᵢ=x₀+i*w, yᵢ is a y-axis coordinate of the lane, zᵢ is a z-axis coordinate of the lane, x₀ is an x-axis coordinate of a starting point of the lane, and w is a width of shelf.

According to the embodiments of the present disclosure, the warehouse includes at least one main channel and a plurality of lanes, the determining coordinates of each of the plurality of storage space nodes includes: determining, for at least one of the at least one main channel, coordinates of a j-th storage space node in the main channel as (xⱼ, yⱼ, zⱼ), an extension direction of the main channel being parallel to a y-axis, wherein xⱼ is an x-axis coordinate of the main channel, yⱼ=y₀+j*d, and zⱼ is a z-axis coordinate of the main channel, and y₀ is a y-axis coordinate of a starting point of the main channel, and d is a distance between each lane adjacent to the main channel.

In another aspect, a device for locating a storage space in a warehouse is provided, including: a first acquisition module used for acquiring a plurality of storage space nodes and a plurality of storage spaces in the warehouse; a mapping module used for establishing respective mapping relationships from the plurality of storage spaces to the plurality of storage space nodes; a coordinate module used for determining coordinates of each of the plurality of storage space nodes; a second acquisition module used for acquiring an item to be operated and determining a storage space to be operated for the item to be operated; a determination module used for determining a target storage space node corresponding to the storage space to be operated according to the mapping relationships; and an output module used for outputting coordinates of the target storage space node.

According to the embodiments of the present disclosure, the mapping module includes: a first acquisition sub-unit used for acquiring a mapping table, wherein the mapping table is used for storing mapping relationships between storage space nodes and a set of storage spaces; a second acquisition sub-unit used for acquiring a quick response code provided for a storage space; and an adding sub-unit used for determining, in response to the storage space represented by the quick response code being not in the mapping table, a storage space node corresponding to the storage space represented by the quick response code according to a preset rule, and adding a mapping relationship from the storage space represented by the quick response code to the storage space node to the mapping table.

According to the embodiments of the present disclosure, the warehouse includes a plurality of lanes, a plurality of shelves are arranged in the lanes, and the coordinate module includes: a first determination sub-unit used for determining, for each lane of the plurality of lanes, coordinates of an i-th storage space node in the lane as (xᵢ, yᵢ, zᵢ), and an extension direction of the lane is parallel to an x-axis, wherein xᵢ=x₀+i*w, yᵢ is a y-axis coordinate of the lane, zᵢ is a z-axis coordinate of the lane, x₀ is an x-axis coordinate of a starting point of the lane and w is a width of shelf.

According to the embodiments of the present disclosure, the warehouse includes at least one main channel and a plurality of lanes, and the determination module includes: a second determination sub-unit used for determining, for at least one of the at least one main channel, coordinates of a j-th storage space node in the main channel as (xⱼ, yⱼ, zⱼ), an extension direction of the main channel being parallel to a y-axis, wherein xⱼ is an x-axis coordinate of the main channel, yⱼ=y₀+j*d, and zⱼ is a z-axis coordinate of the main channel, and y₀ is a y-axis coordinate of a starting point of the main channel and d is a distance between each lane adjacent to the main channel.

In another aspect, there is provided a computer-readable storage medium, storing computer-executable instructions. The computer-executable instructions, when executed, are used for implementing the method as described above.

In another aspect, there is provided a computer program including computer-executable instructions. The instructions, when executed, are used for implementing the method as described above.

### BRIEF DESCRIPTION OF THE DRAWINGS

Through the following description of the embodiments of the present disclosure with reference to the drawings, the above and other objectives, features, and advantages of the present disclosure will be clearer. In the drawings:

FIG. 1 schematically shows a system architecture of a method and device for locating a storage space in a warehouse according to the embodiments of the present disclosure;

FIG. 2 schematically shows a schematic diagram of a warehouse according to the embodiments of the present disclosure;

FIG. 3A schematically shows a flowchart of a method for locating a storage space in a warehouse according to the embodiments of the present disclosure;

FIG. 3B schematically shows a schematic diagram of a warehouse coordinate system according to the embodiments of the present disclosure;

FIG. 3C schematically shows a schematic diagram of another warehouse coordinate system according to the embodiments of the present disclosure;

FIG. 4 schematically shows a flowchart of establishing respective mapping relationships from a plurality of storage spaces to a plurality of storage space nodes according to the embodiments of the present disclosure;

FIG. 5 schematically shows a block diagram of a device for locating a storage space in a warehouse according to the embodiments of the present disclosure;

FIG. 6 schematically shows a block diagram of a mapping module according to the embodiments of the present disclosure;

FIG. 7 schematically shows a block diagram of a coordinate module according to the embodiments of the present disclosure;

FIG. 8 schematically shows a block diagram of a determination module according to the embodiments of the present disclosure; and

FIG. 9 schematically shows a block diagram of a computer system suitable for implementing the above method according to the embodiments of the present disclosure.

### DETAILED DESCRIPTION OF EMBODIMENTS

The embodiments of the present disclosure will be described with reference to the drawings. However, it should be understood that the descriptions are only exemplary, and are not intended to limit the scope of the present disclosure. In the following detailed description, for ease of explanation, many specific details are set forth to provide a comprehensive understanding of the embodiments of the present disclosure. However, it may be understood that one or more embodiments may also be implemented without these specific details. In addition, in the following, descriptions of well-known structures and technologies are omitted to avoid unnecessarily obscuring the concept of the present disclosure.

The terms used herein are only for describing specific embodiments, and are not intended to limit the present disclosure. The terms “including”, “comprising”, etc. used herein indicate an existence of features, steps, operations and/or components, but do not exclude a presence or addition of one or more other features, steps, operations or components.

All terms (including technical and scientific terms) used herein have the meanings commonly understood by those skilled in the art, unless otherwise defined. It should be noted that the terms used here should be interpreted as having meanings consistent with the context of this specification, and should not be interpreted in an idealized or overly rigid manner.

In the case of using an expression similar to “at least one of A, B, and C”, generally speaking, it should be interpreted according to the meaning of the expression commonly understood by those skilled in the art (for example, “a system having at least one of A, B, and C” shall include, but is not limited to, a system having A alone, B alone, C alone, A and B, A and C, B and C, and/or A, B, and C). In a case of using an expression similar to “at least one of A, B, or C”, generally speaking, it should be interpreted according to the meaning of the expression commonly understood by those skilled in the art (for example, “a system having at least one of A, B, or C” shall include but is not limited to a system having A alone, B alone, C alone, A and B, A and C, B and C, and/or A, B, and C).

According to the embodiments of the present disclosure, a method for locating a storage space in a warehouse and a device capable of applying the method are provided. The method includes: acquiring a plurality of storage space nodes and a plurality of storage spaces in the warehouse; establishing respective mapping relationships from the plurality of storage spaces to the plurality of storage space nodes; determining coordinates of each of the plurality of storage space nodes; acquiring an item to be operated, and determining a storage space to be operated for the item to be operated; determining a target storage space node corresponding to the storage space to be operated according to the mapping relationships; and outputting coordinates of the target storage space node.

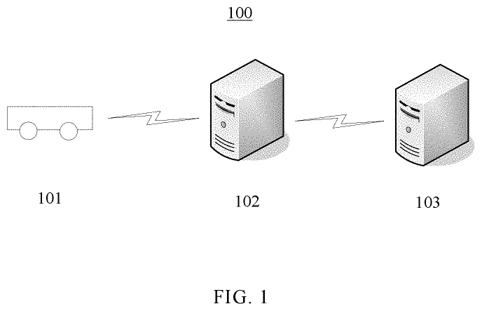

FIG. 1 schematically shows an exemplary system architecture 100 that may be applied to a method and device for locating a storage space in a warehouse according to the embodiments of the present disclosure. It should be noted that FIG. 1 only shows an example of the system architecture that may be applied to the embodiments of the present disclosure, to help those skilled in the art understand technical contents of the present disclosure. However, it does not mean that the embodiments of the present disclosure cannot be used in other devices, systems, environments, or scenarios.

As shown in FIG. 1, the system architecture 100 according to the embodiments may include an autonomous mobile device 101, a task management and control server 102, and a warehouse management server 103.

The autonomous mobile device 101 is a power-driven device with autonomous movement capability for performing a transportation task, such as a drone, an unmanned vehicle, a robot, etc.

The warehouse management server 103 is used for generating an inventory operation request, and transmitting the inventory operation request to the task management and control system 102.

The task management and control server 102 is used to perform logical processing after responding to the inventory operation request, allocate related resources, and dispatch the autonomous mobile device 101 to complete a corresponding inventory operation.

It should be noted that the method for locating the storage space in the warehouse provided by the embodiments of the present disclosure may generally be performed by the task management and control server 102. Correspondingly, the device for locating the storage space in the warehouse provided by the embodiments of the present disclosure may generally be disposed in the task management and control server 102. The method for locating the storage space in the warehouse provided by the embodiments of the present disclosure may also be performed by a server or a server cluster that is different from the task management and control server 102 and able to communicate with the autonomous mobile device 101 and/or the warehouse management system 103. Correspondingly, the device for locating the storage space in the warehouse provided by the embodiments of the present disclosure may also be disposed in a server or a server cluster that is different from the task management and control server 102 and able to communicate with the autonomous mobile device 101 and/or the warehouse management system 103.

It should be understood that the numbers of the autonomous mobile device 101, the task management and control server 102, and the warehouse management server 103 in FIG. 1 are merely illustrative. According to implementation needs, there may be any number of autonomous mobile devices 101, task management and control servers 102, and warehouse management servers 103.

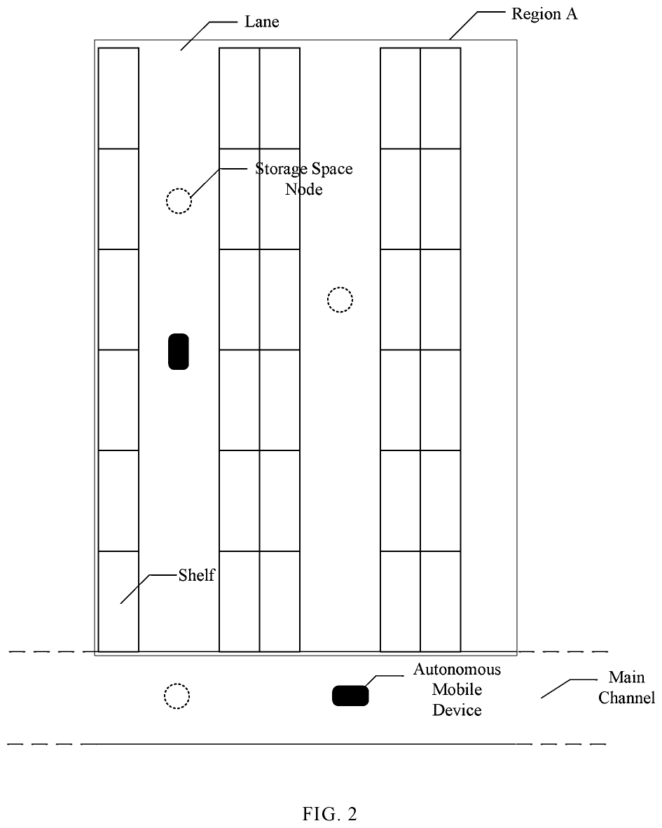

FIG. 2 schematically shows a schematic diagram of a warehouse according to the embodiments of the present disclosure. The warehouse includes a main channel, lanes, shelves, storage space nodes and autonomous mobile devices.

The main channel and the lanes are areas for the autonomous mobile devices to travel. The storage space nodes are parking spots for the autonomous mobile devices, and the storage space nodes may be set in the lanes or in the main channel. The autonomous mobile devices may travel in the main channel and the lanes, so as to reach a corresponding storage space node.

A plurality of shelves are provided in the warehouse, which are arranged along both sides of the lanes. Each shelf includes several layers, and each layer includes one or more storage spaces. For shelves with the same number of storage space and the same width of storage space on each layer, all storage spaces in the same column in the shelf form a storage space column. For shelves with different numbers of storage space or different widths of storage space on each layer, all storage spaces in each shelf form a storage space column.

In addition, the plurality of shelves and the lanes may form a region (for example, a region A shown by a dashed box in FIG. 2).

It should be understood that the numbers of the main channel, lanes, storage space columns, storage space nodes, and autonomous mobile devices in FIG. 2 are merely illustrative. According to implementation needs, there may be any number of main channels, lanes, storage space columns, storage space nodes, and autonomous mobile devices.

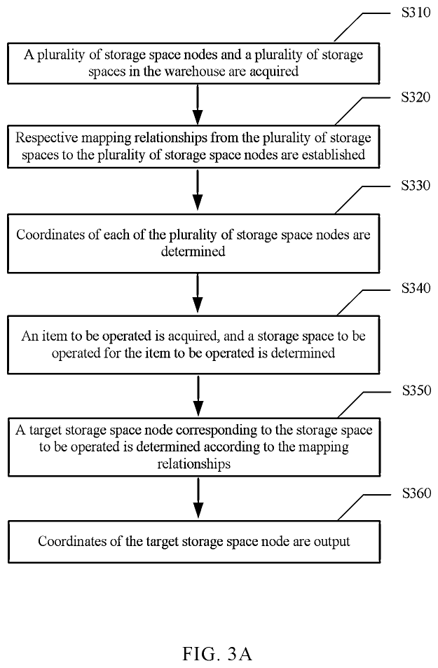

FIG. 3A schematically shows a flowchart of a method for locating a storage space in a warehouse according to the embodiments of the present disclosure.

As shown in FIG. 3A, the method includes operations S310 to S360.

In operation S310, a plurality of storage space nodes and a plurality of storage spaces in the warehouse are acquired.

According to the embodiments of the present disclosure, operation S310 may include, for example, acquiring serial numbers of a plurality of storage space nodes and serial numbers of a plurality of storage spaces in the warehouse.

According to the embodiments of the present disclosure, each storage space has a unique serial number. A serial number of a storage space is in a form of “region number-lane serial number-serial number of storage space column-layer number”. The serial number of the storage space column is odd on one side of the lane, and is even on the other side of the lane. For example, in FIG. 2, the serial number of the storage space column on the left side of each lane is an odd number, and the serial number of the storage space column on the right side is an even number.

For example, for a storage space in a region AA2F, a 66th lane, a 001th column, and a 03th layer, a serial number of the storage space is AA2F-66-001-03 according to the above rules.

According to the embodiments of the present disclosure, each storage space node also has a unique serial number, such as 1818, 1819, 1820, etc. The serial number of the storage space node may be manually designated.

In other embodiments of the present disclosure, the serial number of the storage space node may also be set according to the following method: the task management and control server instructs the autonomous mobile device to stop at a designated position and to upload coordinates of the position to the task management and control server; the task management and control server generates a serial number for the storage space node according to a numbering rule, and corresponds the serial number of the storage space node to the coordinates; and a corresponding relationship between the serial number of the storage space node and the coordinates is stored in a mapping table of storage space node and coordinate.

In operation S320, respective mapping relationships from the plurality of storage spaces to the plurality of storage space nodes are established.

According to the embodiments of the present disclosure, operation S320 may be, for example, mapping a serial number of each storage space to a serial number of a corresponding storage space node according to a preset rule, and the mapping relationship between the serial number of the storage space and the serial number of the corresponding storage space node is stored in a mapping table of storage space and storage space node.

According to the embodiments of the present disclosure, the preset rule includes that a plurality of storage spaces correspond to one storage space node, and all storage spaces in the same storage space column correspond to the same storage space node.

According to other embodiments of the present disclosure, the preset rule may further include: mapping storage spaces in each storage space column of some adjacent shelves in the same lane to the same storage space node. In this way, as long as these storage spaces are located in the same column and in the same shelf, these storage spaces are all mapped to the same storage space node, no matter which layer they are on. Table 1 exemplarily shows a mapping table of storage spaces and storage space nodes established according to the preset rule.

TABLE 1

| | Storage | Storage | Storage | Storage | |
|---|---|---|---|---|---|
| Storage | space | space | space | space | |
| space | column | column | column | column | |
| node | 1 | 2 | 3 | 4 | . . . |
| 1818 | AA2F- | AA2F- | AA2F- | AA2F- | . . . |
| | 66-001 | 66-003 | 66-002 | 66-004 | |
| 1819 | AA2F- | AA2F- | AA2F- | AA2F- | . . . |
| | 67-001 | 67-003 | 67-002 | 67-004 | |
| 1820 | AA2F- | AA2F- | AA2F- | AA2F- | . . . |
| | 68-001 | 68-003 | 68-005 | 68-007 | |
| . . . | . . . | . . . | . . . | . . . | . . . |

In other embodiments of the present disclosure, the preset rule may further include: mapping all storage spaces in the same lane, whose distance from a storage space node is less than a distance threshold, to the storage space node.

In operation S330, coordinates of each of the plurality of storage space nodes are determined.

According to the embodiments of the present disclosure, operation S330 may include, for example, constructing a warehouse coordinate system, and determining the coordinates of each storage space node according to the warehouse coordinate system.

According to the embodiments of the present disclosure, the warehouse includes a plurality of lanes, and the storage space nodes may be set in the lanes to facilitate the picking work of the autonomous mobile devices. In this case, operation S330 includes, for each lane in the warehouse, determining coordinates of an i-th storage space node in the lane as (xᵢ, yᵢ, zᵢ), assuming an extension direction of the lane parallel to an x-axis.

Here, yᵢ is a y-axis coordinate of the lane, zᵢ is a z-axis coordinate of the lane, xᵢ=x₀+i*w, x₀ is an x-axis coordinate of a starting point of the lane, and w is a width of shelf.

According to the embodiments of the present disclosure, as shown in FIG. 3B, due to a width of lane, a y-axis coordinate of a center line of the lane may be set as the y-axis coordinate of the lane, and the z-axis coordinate of the lane is 0.

For example, a storage space node 1818 is a third storage space node in lane 1, a y-axis coordinate of lane 1 is 66, and a z-axis coordinate of lane 1 is 0. Besides, an x-axis coordinate x₀ of a starting point of lane 1 is 60, and a width of shelf w is 4. According to the formula xᵢ=x₀+i*w, xᵢ is 72. As a result, coordinates of the storage space node are (72,66,0).

According to other embodiments of the present disclosure, as shown in FIG. 3C, the warehouse includes at least one main channel and a plurality of lanes, and the storage space node may also be set in the main channel as a temporary parking spot. In this case, operation S330 includes, for the main channel provided with the storage space node in the warehouse, determining coordinates of a j-th storage space node in the main channel as (xⱼ, yⱼ, zⱼ), assuming an extension direction of the main channel parallel to the y-axis. Here, xⱼ is an x-axis coordinate of the main channel, zⱼ is a z-axis coordinate of the main channel, yⱼ=y₀+j*d, y₀ is a y-axis coordinate of a starting point of the main channel, and d is a distance between each lane adjacent to the main channel.

According to the embodiments of the present disclosure, as shown in FIG. 3C, due to a width of main channel, an x-axis coordinate of a center line of the main channel may be set as the x-axis coordinate of the main channel, the z-axis coordinate of the main channel is 0, and d is a difference between y-axis coordinates of two lanes.

For example, a storage space node 1819 is a second storage space node in main channel 1, an x-axis coordinate of main channel 1 is 38, and a z-axis coordinate of main channel 1 is 0. Besides, a y-axis coordinate y₀ of a starting point of main channel 1 is 62, and a distance d between each lane adjacent to the main channel is 3. According to the formula yⱼ=y₀+j*d, yⱼ is 68. As a result, coordinates of the storage space node are (38,68,0).

According to other embodiments of the present disclosure, after operation S330, the method may further include: storing the coordinates of the storage space nodes into the mapping table of storage space node and coordinate. Table 2 schematically shows a mapping table of storage space node and coordinate.

TABLE 2

| Serial number | | | |
|---|---|---|---|
| of storage | Coordinate | Coordinate | Coordinate |
| space node | X | Y | Z |
| 1818 | 72 | 66 | 0 |
| 1819 | 38 | 68 | 0 |
| . . . | . . . | . . . | . . . |

According to other embodiments of the present disclosure, if the mapping table of storage space node and coordinate has already stored the coordinates of each storage space node, operation S330 may include reading the coordinates of each storage space node from the mapping table of storage space node and coordinate.

In operation S340, an item to be operated is acquired, and a storage space to be operated for the item to be operated is determined.

According to the embodiments of the present disclosure, operation S340 may include, for example, acquiring an inventory operation request; determining an item that need to be put into or taken out of the warehouse according to the inventory operation request as the item to be operated; for an item that need to be put into the warehouse, allocating a corresponding storage space in free storage spaces for the item, according to a product category (such as home appliances, clothing, books, etc.) of the item or a product characteristic (such as refrigeration, fragility, etc.) of the item, the storage space is used as the storage space to be operated, then recording a SKU (stock keeping unit) of the item and a serial number of the allocated storage space in a database; and for an item that need to be taken out of the warehouse, looking up a serial number of the storage space corresponding to a SKU of the item in the database, a storage space corresponding to the serial number of the storage space is used as the storage space to be operated.

In operation S350, a target storage space node corresponding to the storage space to be operated is determined according to the mapping relationships.

According to the embodiments of the present disclosure, operation S350 may include, for example, looking up a storage space node corresponding to the storage space to be operated from the mapping relationship table of storage space and storage space node (for example, Table 1), as the target storage space node.

In operation S360, coordinates of the target storage space node are output.

According to the embodiments of the present disclosure, operation S360 may include, for example, acquiring the coordinates of the target storage space node; transmitting the coordinates of the target storage space node to the autonomous mobile device, so that the autonomous mobile device may travel to the target storage space node to perform a corresponding picking operation.

Exemplarily, according to other embodiments of the present disclosure, for the target storage space node acquired in S350, corresponding coordinates may be looked up in the mapping table of storage space node and coordinate (for example, Table 2) according to a serial number of the target storage space node, so as to acquire the coordinates of the target storage space node; the coordinates of the target storage space node may be transmitted to the autonomous mobile device, so that the autonomous mobile device may travel to the target storage space node to perform a corresponding picking operation.

According to the embodiments of the present disclosure, by establishing the mapping relationships between the storage spaces and the storage space nodes, and by determining the coordinates of the storage space nodes, the coordinates of the target storage space node may be provided to the autonomous mobile device, so that the autonomous mobile device may reach the position of the target storage space node to complete the transportation task, thereby improving the efficiency of picking and reducing labor costs.

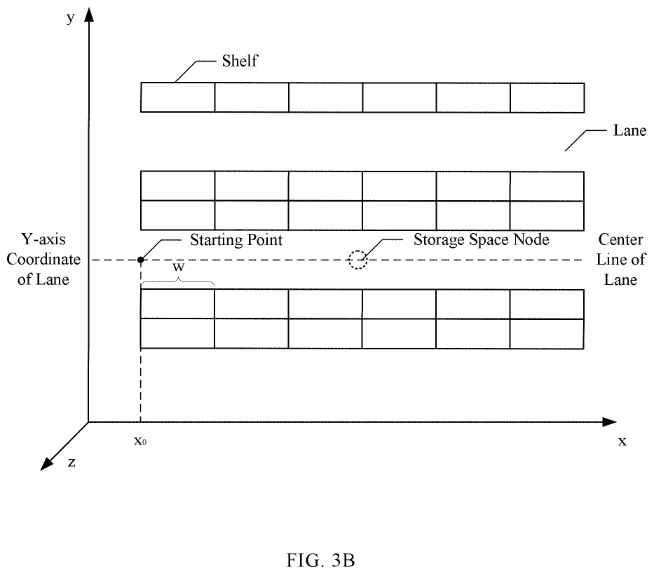

FIG. 4 schematically shows a flowchart of establishing respective mapping relationships from a plurality of storage spaces to a plurality of storage space nodes according to the present disclosure.

As shown in FIG. 4, operation S320 may include the following operations S410 to S430, for example.

In operation S410, a mapping table is acquired.

The mapping table is used for storing mapping relationships between storage spaces and storage space nodes.

In operation S420, a quick response code provided for a storage space is acquired.

According to the embodiments of the present disclosure, operation S420 may include, for example, instructing the autonomous mobile device to traverse each storage space, and instructing the autonomous mobile device to capture an image on the storage space using a camera; and finding a quick response code in the image.

In operation S430, if the storage space represented by the quick response code is not in the mapping table, a storage space node corresponding to the storage space represented by the quick response code is determined according to a preset rule, and a mapping relationship from the storage space represented by the quick response code to the storage space node is added to the mapping table.

According to other embodiments of the present disclosure, if the mapping relationships between the storage spaces and the storage space nodes are established according to a rule of “mapping each storage space in each storage space column of a shelf to the same storage space node”, then operation S430 may include: acquiring, based on the quick response code acquired in S420, a serial number of the storage space corresponding to the quick response code according to the corresponding relationship between the quick response code and the storage space, where the quick response code is in one-to-one correspondence with the serial number of the storage space; determining a serial number of a storage space column where the storage space is located according to the serial number of the storage space (since the serial number of the storage space is in the form of “region number-lane serial number-serial number of storage space column-layer number”); and mapping the serial number of the storage space column to a serial number of a corresponding storage space node, and adding the mapping relationship to the mapping table.

According to the embodiments of the present disclosure, by acquiring the quick response code provided for the storage spaces, and adding the mapping relationship from the storage space represented by the QR code to the storage space node to the mapping table according to the preset rule, the mapping relationships from the storage spaces to the storage space nodes may be automatically established, so as to save manpower.

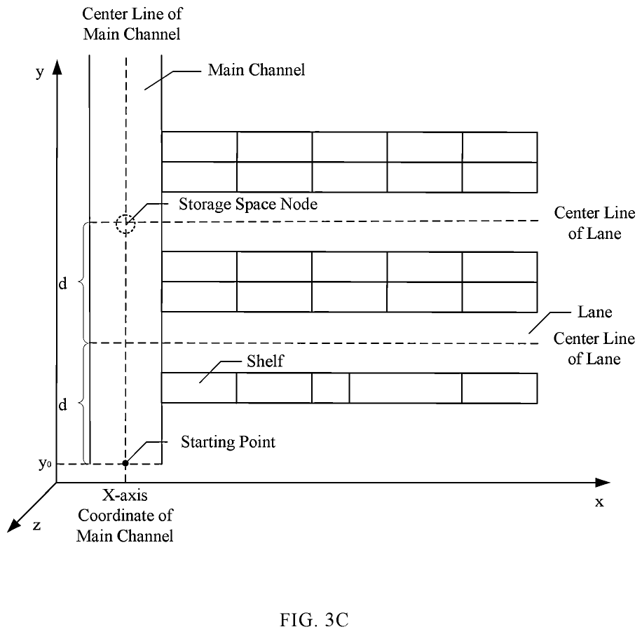

FIG. 5 schematically shows a block diagram of a device for locating a storage space in a warehouse according to the embodiments of the present disclosure.

As shown in FIG. 5, the device 500 includes a first acquisition module 510, a mapping module 520, a coordinate module 530, a second acquisition module 540, a determination module 550, and an output module 560.

The first acquisition module 510 is used for acquiring a plurality of storage space nodes and a plurality of storage spaces in the warehouse.

The mapping module 520 is used for establishing respective mapping relationships from the plurality of storage spaces to the plurality of storage space nodes.

The coordinate module 530 is used for determining coordinates of each of the plurality of storage space nodes.

The second acquisition module 540 is used for acquiring an item to be operated and determining a storage space to be operated for the item to be operated.

The determination module 550 is used for determining a target storage space node corresponding to the storage space to be operated according to the mapping relationships.

The output module 560 is used for outputting coordinates of the target storage space node.

According to the embodiments of the present disclosure, by establishing the mapping relationships between the storage spaces and the storage space nodes, and by determining the coordinates of the storage space nodes, the coordinates of the target storage space node may be provided to the autonomous mobile device, so that the autonomous mobile device may reach the position of the target storage space node to complete the picking operation, thereby improving the efficiency of picking and reducing labor costs.

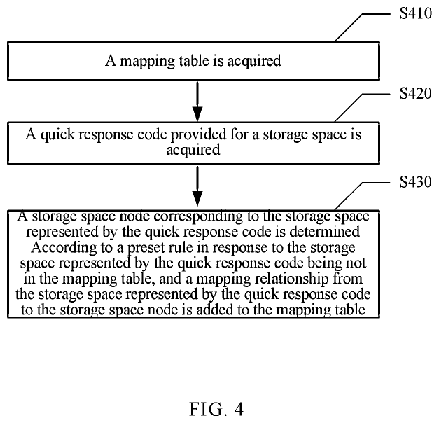

FIG. 6 schematically shows a block diagram of a mapping module according to the embodiments of the present disclosure.

As shown in FIG. 6, according to the embodiments of the present disclosure, the mapping module 520 includes: a first acquisition sub-unit 610, a second acquisition sub-unit 620, and an adding sub-unit 630.

The first acquisition sub-unit 610 is used for acquiring a mapping table, where the mapping table is used for storing mapping relationships between storage space nodes and a set of storage spaces.

The second acquisition sub-unit 620 is used for acquiring a quick response code provided for a storage space.

The adding sub-unit 630 is used for determining, if the storage space represented by the quick response code is not in the mapping table, a storage space node corresponding to the storage space represented by the quick response code according to a preset rule and adding a mapping relationship from the storage space represented by the quick response code to the storage space node to the mapping table.

According to the embodiments of the present disclosure, by acquiring the quick response code provided for the storage spaces, and by adding the mapping relationship from the storage space represented by the quick response code to the storage space node to the mapping table according to the preset rule, it is possible to automatically establish the mapping relationships between the storage spaces and the storage space nodes, so as to save manpower.

According to the embodiments of the present disclosure, the preset rule includes that a plurality of storage spaces correspond to one storage space node, and all storage spaces in the same storage space column correspond to the same storage space node.

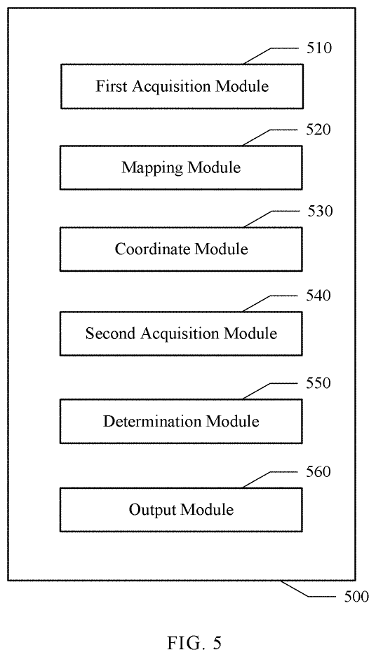

FIG. 7 schematically shows a block diagram of a coordinate module according to the embodiments of the present disclosure.

As shown in FIG. 7, according to the embodiments of the present disclosure, the coordinate module 530 includes: a first determination sub-unit 710 used for determining, for each lane of the plurality of lanes, coordinates of an i-th storage space node in the lane as (xᵢ, yᵢ, zᵢ), where an extension direction of the lane is parallel to the x-axis, xᵢ=x₀+i*w, yᵢ is a y-axis coordinate of the lane, and zᵢ is a z-axis coordinate of the lane, x₀ is an x-axis coordinate of a starting point of the lane, and w is a width of shelf.

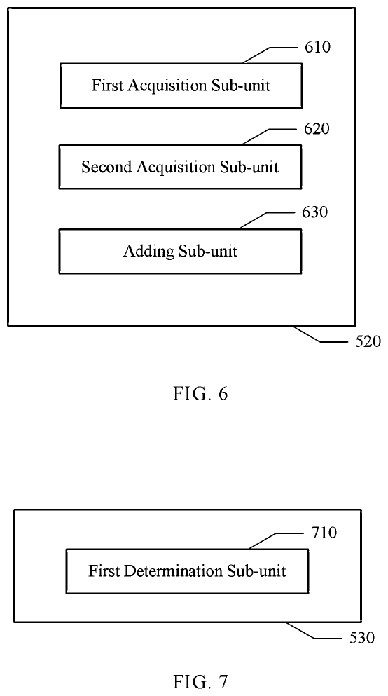

FIG. 8 schematically shows a block diagram of a determination module according to the embodiments of the present disclosure.

As shown in FIG. 8, according to the embodiments of the present disclosure, the determination module 550 includes: a second determination sub-unit 810 used for determining, for at least one of the at least one main channel, coordinates of a j-th storage space node in the main channel as (xⱼ, yⱼ, zⱼ), where an extension direction of the main channel is parallel to the y-axis, xⱼ is an x-axis coordinate of the main channel, yⱼ=y₀+j* d, zⱼ is a z-axis coordinate of the main channel, the y₀ is a y-axis coordinate of a starting point of the main channel, and d is a distance between each lane adjacent to the main channel.

According to the embodiments of the present disclosure, any two or more of the modules and sub-units, or at least part of functions of the any two or more of the modules and sub-units may be implemented in one module. Any one or more of the modules, sub-modules, units, and sub-units according to the embodiments of the present disclosure may be split into a plurality of modules for implementation. Any one or more of the modules, sub-modules, units, and sub-units according to the embodiments of the present disclosure may be at least partially implemented as a hardware circuit, such as a field programmable gate array (FPGA), a programmable logic array (PLA), a system on chip, a system on substrate, a system on package, an application specific integrated circuit (ASIC); or may be implemented by hardware or firmware in any other reasonable way that integrates or encapsulates circuits; or may be implemented by any of software, hardware, and firmware, or an appropriate combination of any of them. Alternatively, one or more of the modules, sub-modules, units, and sub-units according to the embodiments of the present disclosure may be at least partially implemented as a computer program module, and when the computer program module is executed, a corresponding function may be performed.

For example, any two or more of the first acquisition module 510, the mapping module 520, the coordinate module 530, the second acquisition module 540, the determination module 550, the output module 560, the first acquisition sub-unit 610, the second acquisition sub-unit 620, the adding sub-unit 630, the first determination sub-unit 710 and the second determination sub-unit 810 may be integrated into one module for implementation, or any one of the modules may be split into a plurality of modules. Alternatively, at least part of the functions of one or more of these modules may be combined with at least part of the functions of other modules and implemented in one module. According to the embodiments of the present disclosure, at least one of the first acquisition module 510, the mapping module 520, the coordinate module 530, the second acquisition module 540, the determination module 550, the output module 560, the first acquisition sub-unit 610, the second acquisition sub-unit 620, the adding sub-unit 630, the first determination sub-unit 710 and the second determination sub-unit 810 may be at least partially implemented as a hardware circuit, for example, a field programmable gate array (FPGA), a programmable logic array (PLA), a system on chip, a system on substrate, a system on package, an application specific integrated Circuit (ASIC); or may be implemented by a hardware or firmware in any other reasonable way that integrates or encapsulates circuits; or may be implemented by any one of software, hardware, and firmware, or an appropriate combination of any of them. Alternatively, at least one of the first acquisition module 510, the mapping module 520, the coordinate module 530, the second acquisition module 540, the determination module 550, the output module 560, the first acquisition sub-unit 610, the second acquisition sub-unit 620, the adding sub-unit 630, the first determination sub-unit 710 and the second determination sub-unit 810 may be at least partially implemented as a computer program module, and when the computer program module is executed, a corresponding function may be performed.

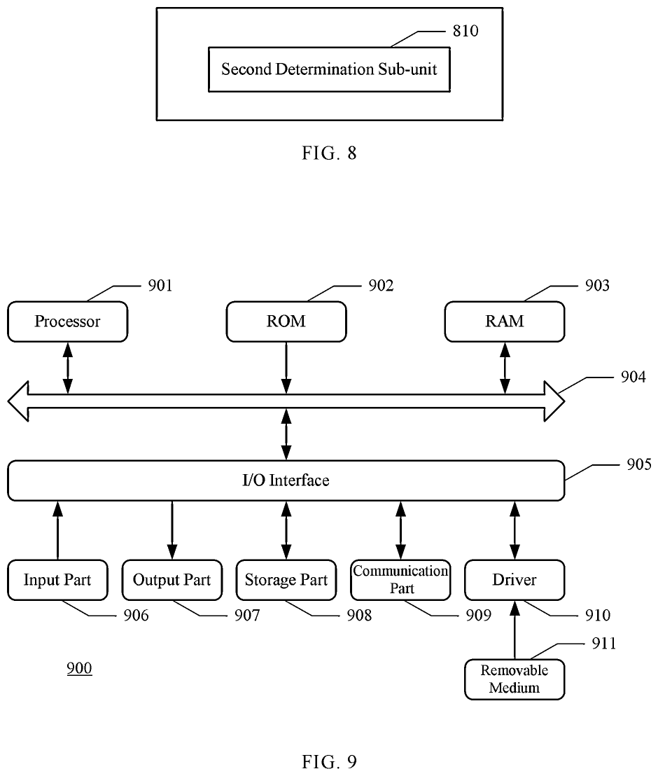

FIG. 9 schematically shows a block diagram of a computer system suitable for implementing the above-described method according to the embodiments of the present disclosure. However, the computer system shown in FIG. 9 is only an example, and no limitation should be imposed on the function and scope of use of the embodiments of the present disclosure.

As shown in FIG. 9, the computer system 900 according to the embodiments of the present disclosure includes a processor 901, which may perform various appropriate actions and processes according to a program stored in a read only memory (ROM) 902 or a program loaded from a storage part 908 into a random access memory (RAM) 903. The processor 901 may include, for example, a general purpose microprocessor (e.g., a CPU), an instruction set processor, a related chipset, and/or a special purpose microprocessor (e.g., an application specific integrated circuit (ASIC)). The processor 901 may also include on-board memory for caching purposes. The processor 901 may include a single processing unit or a plurality of processing units for performing different actions of the method flow according to the embodiments of the present disclosure.

In the RAM 903, various programs and data required for the operation of the system 900 are stored. The processor 901, the ROM 902, and the RAM 903 are connected to each other through a bus 904. The processor 901 performs various operations of the method flow according to the embodiments of the present disclosure by executing a program in the ROM 902 and/or RAM 903. It should be noted that the program may also be stored in one or more memories other than the ROM 902 and the RAM 903. The processor 901 may also perform various operations of the method flow according to the embodiments of the present disclosure by executing programs stored in the one or more memories.

According to the embodiments of the present disclosure, the system 900 may further include an input/output (I/O) interface 905, and the input/output (I/O) interface 905 is also connected to the bus 904. The system 900 may further include one or more of the following components connected to the I/O interface 905: an input part 906 including a keyboard, a mouse, etc.; an output part 907 including a cathode ray tube (CRT), a liquid crystal display (LCD), a speaker, etc.; the storage part 908 including a hard disk, etc.; a communication part 909 of a network interface card including a LAN card, a modem, etc. The communication part 909 performs communication processing via a network such as the Internet. A driver 910 is also connected to the I/O interface 905 as needed. A removable medium 911, such as a magnetic disk, an optical disk, a magneto-optical disk, a semiconductor memory, etc., is installed on the driver 910 as needed, so that a computer program read therefrom is installed into the storage part 908 as needed.

According to the embodiments of the present disclosure, the method flow may be implemented as a computer software program. For example, the embodiments of the present disclosure include a computer program product, which includes a computer program stored in a computer-readable storage medium, and the computer program includes program codes for performing the method shown in the flowchart. In such embodiment, the computer program may be downloaded and installed from the network through the communication part 909, and/or installed from the removable medium 911. When the computer program is executed by the processor 901, it performs the above-mentioned functions defined in the system of the embodiments of the present disclosure. According to the embodiments of the present disclosure, the system, equipment, devices, modules, units, etc. described above may be implemented by computer program modules.

According to the present disclosure, there is also provided a computer-readable storage medium. The computer-readable storage medium may be included in the equipment/devices/system described in the above embodiments; or may exist in an independent form without being installed into the equipment/devices/system. The foregoing computer-readable storage medium stores one or more programs, and when the one or more programs are executed, the method according to the embodiments of the present disclosure is implemented.

According to the embodiments of the present disclosure, the computer-readable storage medium may be a non-volatile computer-readable storage medium. For example, it may include but not limited to: a portable computer disk, a hard disk, a random access memory (RAM), a read-only memory (ROM), an erasable programmable only read memory (EPROM or flash memory), a portable compact disk read-only memory (CD-ROM), an optical storage device, a magnetic storage device, or any suitable combination of the above. In the present disclosure, the computer-readable storage medium may be any tangible medium that contains or stores a program that may be used by or used in combination with an instruction execution system, apparatus, or device. For example, according to the embodiments of the present disclosure, the computer-readable storage medium may include one or more memories other than the ROM 902, and/or the RAM 903, and/or the ROM 902 and RAM 903 described above.

The flowcharts and block diagrams in the drawings illustrate the possible implementation architecture, functions, and operations of the system, method, and computer program product according to various embodiments of the present disclosure. In this regard, each block in the flowcharts or block diagrams may represent a module, a program segment, or part of codes, and the above-mentioned module, the program segment, or part of the codes contains one or more executable instructions for realizing a specified logic function. It should also be noted that, in some alternative implementations, functions marked in the blocks may also occur in a different order from the order marked in the drawings. For example, two blocks shown in succession may actually be performed substantially in parallel, and they may sometimes be performed in a reverse order, depending on the functions involved. It should also be noted that each block in the block diagrams or flowcharts, and a combination of blocks in the block diagrams or flowcharts, may be implemented by a dedicated hardware-based system that performs the specified functions or operations, or may be implemented by a combination of a dedicated hardware and computer instructions.

Those skilled in the art may understand that the features described in the respective embodiments of the present disclosure and/or the features described in the claims may be combined and/or integrated in various ways, even if such combinations or integrations are not explicitly described in the present disclosure. In particular, without departing from the spirit and teachings of the present disclosure, the features described in the various embodiments of the present disclosure and/or the features described in the claims may be combined and/or integrated in various ways. All these combinations and/or integrations fall within the scope of the present disclosure.

The embodiments of the present disclosure have been described above. However, these examples are for illustrative purposes only, and are not intended to limit the scope of the present disclosure. Although the respective embodiments are described above, this does not mean that the measures in the respective embodiments may not be advantageously used in combination. The scope of the present disclosure is defined by the claims appended and their equivalents. Without departing from the scope of the present disclosure, those skilled in the art may make a plurality of substitutions and modifications, and these substitutions and modifications should fall within the scope of the present disclosure.

1. A method for locating a storage space in a warehouse, comprising:
acquiring a plurality of storage space nodes and a plurality of storage spaces in the warehouse;
establishing respective mapping relationships from the plurality of storage spaces to the plurality of storage space nodes;
determining coordinates of each of the plurality of storage space nodes;
acquiring an item to be operated, and determining a storage space to be operated for the item to be operated;
determining a target storage space node corresponding to the storage space to be operated according to the mapping relationships; and
outputting coordinates of the target storage space node.

2. The method according to claim 1, wherein the establishing respective mapping relationships from the plurality of storage spaces to the plurality of storage space nodes comprises:
acquiring a mapping table, wherein the mapping table is used for storing mapping relationships between storage space nodes and a set of storage spaces;
acquiring a quick response code provided for a storage space; and
determining, in response to the storage space represented by the quick response code being not in the mapping table, a storage space node corresponding to the storage space represented by the quick response code according to a preset rule, and adding a mapping relationship from the storage space represented by the quick response code to the storage space node to the mapping table.

3. The method according to claim 2, wherein the preset rule comprises: a plurality of storage spaces correspond to one storage space node, and all storage spaces in the same storage space column correspond to the same storage space node.

4. The method according to claim 1, wherein the warehouse comprises a plurality of lanes, and a plurality of shelves are arranged in the lanes, the determining coordinates of each of the plurality of storage space nodes comprises:
determining, for each lane of the plurality of lanes, coordinates of an i-th storage space node in the lane as (xᵢ,yᵢ,zᵢ), an extension direction of the lane being parallel to an x-axis,
wherein xᵢ=x₀+i*w, yᵢ is a y-axis coordinate of the lane, and zᵢ is a z-axis coordinate of the lane, and
x₀ is an x-axis coordinate of a starting point of the lane, and w is a width of shelf.

5. The method according to claim 1, or wherein the warehouse comprises at least one main channel and a plurality of lanes, the determining coordinates of each of the plurality of storage space nodes comprises:
determining, for at least one of the at least one main channel, coordinates of a j-th storage space node in the main channel as (xⱼ,yⱼ,zⱼ), an extension direction of the main channel being parallel to a y-axis,
wherein xⱼ is an x-axis coordinate of the main channel, yⱼ=y₀+j*d and zⱼ is a z-axis coordinate of the main channel, and
y₀ is a y-axis coordinate of a starting point of the main channel, and d is a distance between each lane adjacent to the main channel.

6-9. (canceled)

10. A system for locating a storage space in a warehouse, comprising:
one or more processors;
a storage device for storing one or more programs,
wherein the one or more programs, when executed by the one or more processors, cause the one or more processors to implement operations for locating a storage space in a warehouse, comprising:
acquiring a plurality of storage space nodes and a plurality of storage spaces in the warehouse;
establishing respective mapping relationships from the plurality of storage spaces to the plurality of storage space nodes;
determining coordinates of each of the plurality of storage space nodes;
acquiring an item to be operated, and determining a storage space to be operated for the item to be operated;
determining a target storage space node corresponding to the storage space to be operated according to the mapping relationships; and
outputting coordinates of the target storage space node.

11. A computer-readable storage medium, storing executable instructions thereon, wherein when executed by a processor, the executable instructions cause the processor to implement operations for locating a storage space in a warehouse, comprising:
acquiring a plurality of storage space nodes and a plurality of storage spaces in the warehouse;
establishing respective mapping relationships from the plurality of storage spaces to the plurality of storage space nodes;
determining coordinates of each of the plurality of storage space nodes;
acquiring an item to be operated, and determining a storage space to be operated for the item to be operated;
determining a target storage space node corresponding to the storage space to be operated according to the mapping relationships; and
outputting coordinates of the target storage space node.

12. The method according to claim 4, wherein the warehouse comprises at least one main channel and the plurality of lanes, the determining coordinates of each of the plurality of storage space nodes comprises:
determining, for at least one of the at least one main channel, coordinates of a j-th storage space node in the main channel as (xⱼ,yⱼ,zⱼ), an extension direction of the main channel being parallel to a y-axis,
wherein xⱼ is an x-axis coordinate of the main channel, yⱼ=y₀+j*d, and zⱼ is a z-axis coordinate of the main channel, and
y₀ is a y-axis coordinate of a starting point of the main channel, and d is a distance between each lane adjacent to the main channel.
